(19) United States
(12) Patent Application Publication
(10) Pub. No.: US 2012/0313964 A1
(43) Pub. Date: Dec. 13, 2012

(54) INFORMATION PROCESSING APPARATUS, INFORMATION PROCESSING METHOD, AND PROGRAM

(75) Inventors: Takamasa SATO, Kanagawa (JP); Susumu Nagano, Tokyo (JP); Kazuhiro Nakagomi, Tokyo (JP); Yorimitzu Naito, Saitama (JP); Takayuki Ochi, Kanagawa (JP)

(73) Assignee: SONY CORPORATION, Tokyo (JP)

(21) Appl. No.: 13/485,289

(22) Filed: May 31, 2012

(30) Foreign Application Priority Data
Jun. 13, 2011 (JP) 2011-131015

(51) Int. Cl. G09G 5/00; G06K 9/00

(52) U.S. Cl. 345/619; 382/115

(57) ABSTRACT

An information processing apparatus that acquires familiarity information between a first person and a second person at each of a plurality of points in time in a temporal sequence, and determines a distance between a first node representing the first person and a second node representing the second person at each of the plurality of points in time in a temporal sequence based on a relationship of the familiarity information between the second person and the first person at neighboring points in time in the temporal sequence.

### BACKGROUND

The present disclosure relates to an information processing apparatus, an information processing method, and a program.

As a service for establishing a social network on the Internet, a social networking service (SNS) has been proposed and used. The SNS is primarily intended to provide personal communication and is an information communication tool for promoting communication between friends/acquaintances and establishing a new social relationship by making contact with other people not directly involved.

In the SNS, there is generally known a socialization graph for extracting and visualizing a relationship between users registered in the SNS. However, such a socialization graph merely indicates a relationship at a specific moment (for example, up-to-date relationship).

Japanese Patent Application Laid-Open No. 2009-282574 discloses a technique of creating socialization graphs at a plurality of points in time, extracting variation points in these socialization graphs or a change of the graph size in order to recognize the operational status of the SNS.

### SUMMARY

However, the technique disclosed in Japanese Patent Application Laid-Open No. 2009-282574 is just for recognizing the operational status of the SNS and fails to recognize a change of the relationship between individuals registered users as a factor of the socialization graph.

In light of the foregoing, the present disclosure proposes an information processing apparatus, an information processing method, and a program all for creating a correlation map which allows the user to easily recognize a temporal change of the personal correlation and the relationship intensity.

According to a first exemplary embodiment, the disclosure is directed to an information processing apparatus comprising: a processor that: acquires familiarity information between a first person and a second person at each of a plurality of points in time in a temporal sequence; and determines a distance between a first node representing the first person and a second node representing the second person at each of the plurality of points in time in a temporal sequence based on a relationship of the familiarity information between the second person and the first person at neighboring points in time in the temporal sequence. According to another exemplary embodiment, the disclosure is directed to an information processing method performed by an information processing apparatus, the method comprising: acquiring, by a processor of the information processing apparatus, familiarity information between a first person and a second person at each of a plurality of points in time in a temporal sequence; and determining, by the processor, a distance between a first node representing the first person and a second node representing the second person at each of the plurality of points in time in a temporal sequence based on a relationship of the familiarity information between the second person and the first person at neighboring points in time in the temporal sequence.

According to another exemplary embodiment, the disclosure is directed to an information processing apparatus comprising: means for acquiring familiarity information between a first person and a second person at each of a plurality of points in time in a temporal sequence; and means for determining a distance between a first node representing the first person and a second node representing the second person at each of the plurality of points in time in a temporal sequence based on a relationship of the familiarity information between the second person and the first person at neighboring points in time in the temporal sequence.
According to another exemplary embodiment, the disclosure is directed to a non-transitory computer-readable medium including computer program instructions, which when executed by an information processing apparatus, cause the information processing apparatus to perform the method comprising: acquiring familiarity information between a first person and a second person at each of a plurality of points in time in a temporal sequence; and determining a distance between a first node representing the first person and a second node representing the second person at each of the plurality of points in time in a temporal sequence based on a relationship of the familiarity information between the second person and the first person at neighboring points in time in the temporal sequence.

As described above, according to the present disclosure, it is possible to create a correlation map which allows the user to easily recognize a temporal change of the personal correlation and the relationship intensity.

### BRIEF DESCRIPTION OF THE DRAWINGS

FIG. 1 is a block diagram illustrating a configuration of an information processing apparatus according to a first embodiment of the disclosure;

FIG. 2A is an explanatory diagram illustrating an exemplary correlation map according to the first embodiment of the disclosure;

FIG. 2B is an explanatory diagram illustrating an exemplary correlation map according to the first embodiment of the disclosure;

FIG. 3 is an explanatory diagram illustrating a process of creating a correlation map according to the first embodiment of the disclosure;

FIG. 4 is an explanatory diagram illustrating a process of creating a correlation map according to the first embodiment of the disclosure;

FIG. 5 is an explanatory diagram illustrating a process of creating a correlation map according to the first embodiment of the disclosure;

FIG. 6A is a diagram illustrating a process of creating a correlation map according to the first embodiment of the disclosure;

FIG. 6B is a diagram illustrating a process of creating a correlation map according to the first embodiment of the disclosure;

FIG. 7 is a block diagram illustrating a relationship information creating unit according to the first embodiment of the disclosure;

FIG. 8 is an explanatory diagram illustrating an exemplary method of computing a familiarity according to the first embodiment of the disclosure;

FIG. 9 is an explanatory diagram illustrating an exemplary method of computing a familiarity according to the first embodiment of the disclosure;

FIG. 10 is a flowchart illustrating an exemplary flow of the information processing method according to the first embodiment of the disclosure; and

FIG. 11 is a block diagram illustrating a hardware configuration of the information processing apparatus according to an embodiment of the disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be made in the following sequence.

### (1) First Embodiment

(1-1) Configuration of Information Processing Apparatus

(1-2) Flow of Information Processing Method

(1-3) First Modification

(2) Hardware Configuration of Information Processing Apparatus According to Embodiments of the Present Disclosure

### First Embodiment

<Configuration of Information Processing Apparatus>

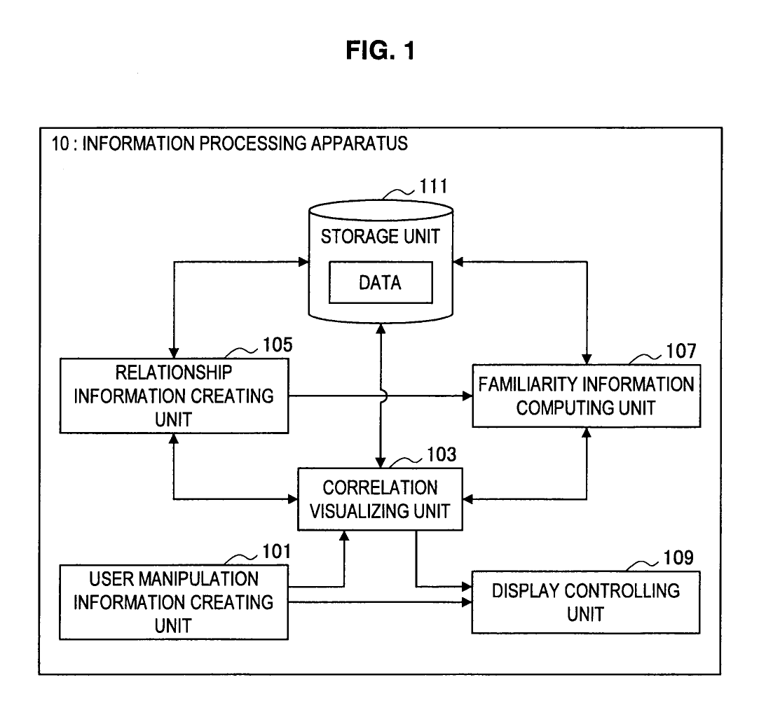

First, a configuration of the information processing apparatus according to the first embodiment of the present disclosure will be described with reference to FIG. 1. FIG. 1 is a block diagram illustrating a configuration of the information processing apparatus according to the present embodiment.

The information processing apparatus according to the present embodiment creates a correlation map for visualizing a correlation between a certain person included in the data group and another person relating to this certain person and a temporal change of the correlation using familiarity information and relationship information computed based on a set of data containing time information (hereinafter, referred to as a data group). Furthermore, the information processing apparatus according to the present embodiment causes a display device of the information processing apparatus or a display device of various devices provided in an outer side of the information processing apparatus to display the created correlation map to provide a user with the correlation map.

Here, the “data containing time information” according to the present embodiment may include, for example, image data such as a still image or a moving picture associated with the metadata regarding the image creation time, text data called history information such as a mail, a blog, a Twitter, a mobile phone, or an e-mail, for which the data creation time (or data transmission time) can be specified, schedule data created by a schedule management application, and the like. Such data contain data itself or information regarding times for the metadata associated with the data. A temporal sequence of such data can be specified by specifying a relative positional relation of such data by focusing on the information on the times. In addition, such data become a source of information capable of specifying a relationship between a certain person and another certain person (for example, friends, a family, a couple, and the like) by analyzing the data. In addition, various data obtained from the SNS may be used as the “data containing time information.”

The relationship information created using such data represents a relationship between persons relating to the data group at each point in time of the temporal sequence of the focused data group. This relationship information contains information, in a database format, for example, representing that a certain person and another certain person are friends, a family (parent and child), a couple, or the like. The familiarity information computed using such data described above represents a familiarity degree between a certain user and another certain user. For example, the familiarity information may contain a value indicating a familiarity degree, a corresponding level obtained by evaluating the familiarity degree, and the like. Such familiarity information may be computed by considering both the familiarity of a person B seen from a person A and the familiarity of the person A seen from the person B as the same value or by considering the familiarity of the person B seen from the person A and the familiarity of the person A seen from the person B as different individual values.

The data containing time information described above may be stored and managed by the information processing apparatus described below or may be stored in various servers provided on various networks such as the Internet. In addition, the relationship information or the familiarity information described above may be created/computed by the information processing apparatus described below or may be created/computed by various servers provided on various networks such as the Internet.

Hereinafter, description will be made for a case where the image data associated with information on the data creation times are used as the data containing time information. In the following example, although description will be made for a case where the information processing apparatus according to the present embodiment has a function of creating/computing the relationship information and the familiarity information described above, the disclosure is not limited thereto.

As illustrated in FIG. 1, the information processing apparatus 10 according to the present embodiment generally includes a user manipulation information creating unit 101, a correlation visualizing unit 103, a relationship information creating unit 105, a familiarity information computing unit 107, a display controlling unit 109, and a storage unit 111.

For example, the user manipulation information creating unit 101 is embodied as a central processing unit (CPU), a read-only memory (ROM), a random access memory (RAM), or an input device. The user manipulation information creating unit 101 creates the user manipulation information indicating a manipulation (user's manipulation) performed by a user using an input device such as a keyboard, a mouse, various buttons, and a touch panel provided in the information processing apparatus 10. As the user manipulation information indicating the user's manipulation is created, the user manipulation information creating unit 101 outputs the created user manipulation information to the correlation visualizing unit 103 and the display controlling unit 109.

The correlation visualizing unit 103 is embodied as a CPU, a ROM, a RAM, or the like. Using the familiarity information and the relationship information computed based on the data group as a set of data containing time information, the correlation visualizing unit 103 sets any single person of such a data group as a reference person and creates a correlation map for visualizing a correlation between the reference person and an associated person who is different from the reference person and associated with the reference person and a temporal change of the correlation. In this case, the correlation visualizing unit 103 extracts one or a plurality of associated persons based on the relationship information out of the data group and determines an offset distance between a node representing the reference person and a node representing the associated person at each point in time of the temporal sequence based on the familiarity information. In addition, the correlation visualizing unit 103 determines an arrangement position of the node representing the associated person considering the correlation of the same person between neighboring points in time in the temporal sequence.

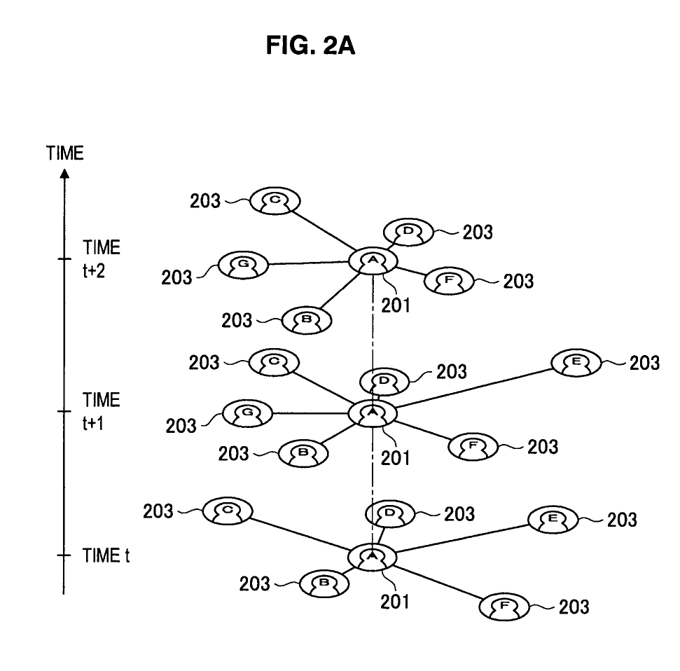

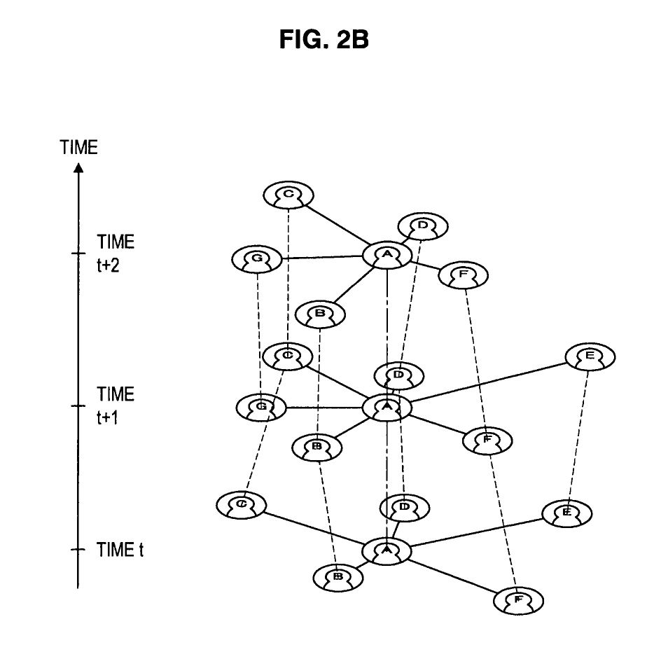

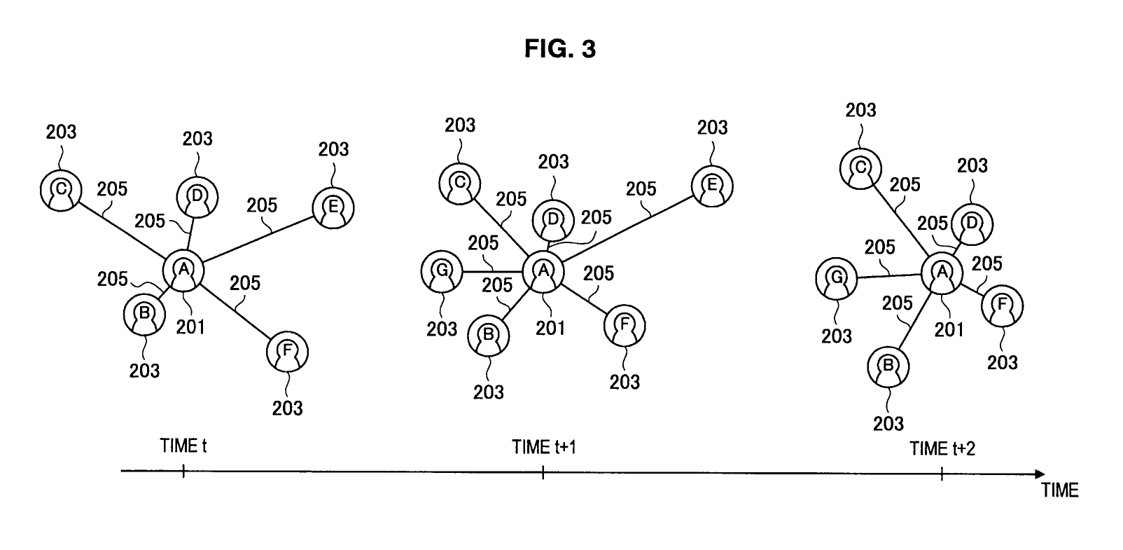

Hereinafter, a correlation visualization process (in other words, a process of creating the correlation map) performed by the correlation visualizing unit 103 according to the present embodiment will be described in detail with reference to FIGS. 2A to 6B. Here, FIGS. 2A and 2B are explanatory diagrams illustrating an exemplary correlation map according to the present embodiment. In addition, FIGS. 3 to 6B are explanatory diagrams illustrating the process of creating the correlation map according to the present embodiment.

FIG. 2A is an explanatory diagram illustrating an exemplary correlation map according to the present embodiment. As shown in FIG. 2A, the correlation map according to the present embodiment is created by extracting a person (hereinafter, referred to as an associated person) associated with the reference person with respect to a person (hereinafter, referred to as a reference person) serving as a reference designated by a user's manipulation or the like. More specifically, the correlation map according to the present embodiment has a three-dimensional structure obtained by stacking correlation diagrams according to the temporal sequence with respect to the reference person, in which an object (reference person object) 201 representing the reference person and objects (associated person object) 203 representing each associated person at each point in time in the temporal sequence are connected with lines having a predetermined length. Although the time axis advances from the bottom to the top of the drawing in the example of FIG. 2A, the time axis may of course advance from the top to the bottom of the drawing.

Here, image data such as a thumbnail image of the corresponding person or an illustration of the corresponding person may be used as the reference person object 201 or the associated person object 203. In addition, text data indicating the corresponding person may be used. In a case where the image data are used as the reference person object 201 and the associated person object 203, it is preferable to use an image cut out from the most appropriate image data (for example, image data created at the date/time closest to the focused point in time) at the focused point in time in the temporal sequence. As a result, the displayed image of the person is also changed depending on a transition of the temporal sequence, and it is possible to support user's intuitive understanding. In addition, as shown in FIG. 2B, a subsidiary line obtained by connecting the same person between each point in time may be additionally displayed. If such a subsidiary line is additionally displayed, a user can easily recognize how the relative position of the associated person object with respect to the reference person object changes as time elapses (in other words, how the correlation between the reference person and the associated person transits).

In order to create such a correlation map, the correlation visualizing unit 103 first creates a correlation diagram of the temporal sequence at each point in time as illustrated in FIG. 3.

When the user manipulation information for requesting to start creation of the correlation map is output from the user manipulation information creating unit 101, the correlation visualizing unit 103 causes the display controlling unit 109 and the like described below to display a message for inquiring who is the reference person on the display screen in order to allow a user to designate the reference person. When the user manipulation information regarding the reference person is output from the user manipulation information creating unit 101, the correlation visualizing unit 103 requests the relationship information creating unit 105 described below to create the relationship information at the time t and requests the familiarity information computing unit 107 described below to compute the familiarity information at the time t based on the obtained information on the reference person.

When the relationship information and the familiarity information are obtained at the time t, the correlation visualizing unit 103 designates who is the person (that is, associated person) associated with the reference person by referencing the relationship information. The correlation visualizing unit 103 uses the object 203 corresponding to the designated associated person as a node on the correlation diagram. In the example of FIG. 3, the reference person is set to the person A, and the correlation visualizing unit 103 designates five persons B to F as the associated persons at the time t by referencing the relationship information.

Next, the correlation visualizing unit 103 specifies the familiarity degree between the reference person and each associated person by referencing the familiarity information at the time t. Furthermore, the correlation visualizing unit 103 determines the length of the line (edge) 205 connecting the reference person object 201 and the associated person object 203 depending on the specified familiarity degree. Here, the correlation visualizing unit 103 may either reduce or increase the length of the edge 205 as the familiarity increases. In the example of FIG. 3, the correlation visualizing unit 103 sets the length of the edge 205 to the length obtained by normalizing the familiarity described in the familiarity information.

The correlation visualizing unit 103 selects the associated person used to create the correlation diagram and determines how to arrange each associated person object 203 on the plane as the length of the edge 205 for the selected associated person is determined. As a method of determining the arrangement of the associated person object 203, any graph drawing method known in the art may be used. However, the correlation visualizing unit 103 may determine the arrangement position of the associated person object 203 based on a spring model as disclosed in Peter Eades, “A heuristic for graph drawing”, Congressus Numerantium, 1984, 42, pp. 149-160.

In the method of using the spring model disclosed in Peter Eades, “A heuristic for graph drawing”, Congressus Numerantium, 1984, 42, pp. 149-160, the node (in the present embodiment, the reference person object 201 and the associated person object 203) is considered as a mass point, the edge is considered as a spring having a predetermined length (in the present embodiment, the length obtained by normalizing the familiarity), and the arrangement of each node is determined so as to obtain the minimum energy in the entire system. Therefore, in the example of the point in time (illustrated time) t of FIG. 3, considering a physical model including six mass points and five springs, the positions of five mass points (mass points corresponding to the associated person object 203) are determined such that a formula for giving energy of the entire system becomes the minimum.

When the correlation diagram is created at the time t, the correlation visualizing unit 103 similarly creates a correlation diagram at the time (t+1). In this case, the correlation visualizing unit 103 adjusts a condition to determine the arrangement of the object such that the positions of the objects of the same person become close considering the correlation of the same person between the neighboring points in time in the temporal sequence. For example, in a case where the arrangement of the object is determined using the spring model, the correlation visualizing unit 103 does not set the arrangement of the object such that the corresponding objects of the same person exist in the same position, but applies a force to the mass point so as to approach the position of the object at the immediately previous time.

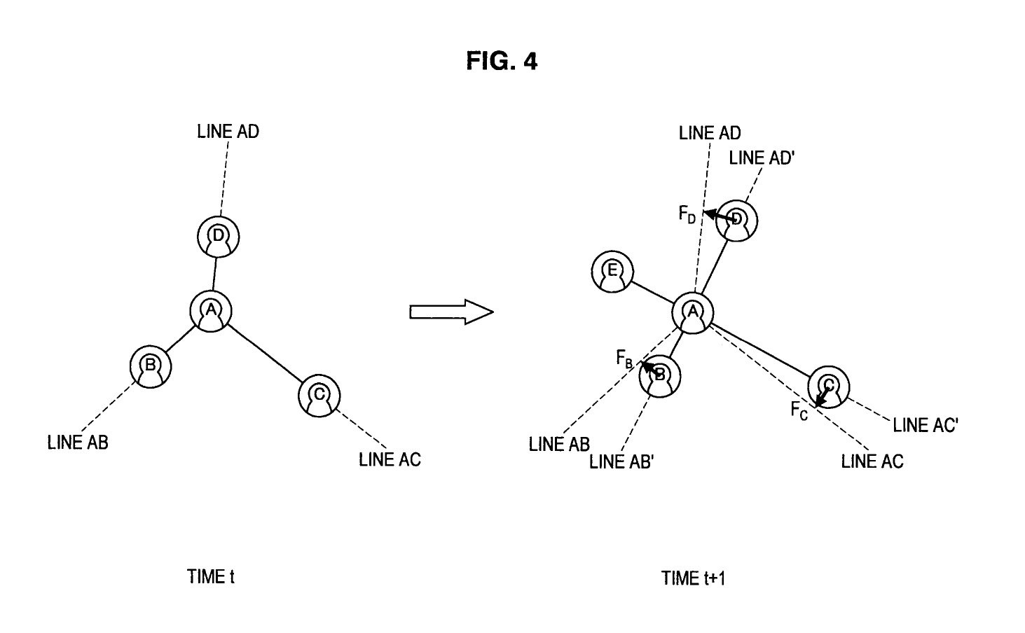

For example, as illustrated in FIG. 4, it is assumed that the person A becomes the reference person, and the persons B to D become the associated persons at the time t to create the correlation diagram. When the correlation diagram is created at the time (t+1), the correlation visualizing unit 103 applies a force to the mass point such that the object approaches the position of each associated person object at the time t which is the immediately previous time. That is, it is assumed that, at the point in time of the time (t+1) of FIG. 4, the initial position of the person B is represented as a line AB′, and the position of the person B at the time t is represented as a line AB, the correlation visualizing unit 103 performs computation for determining the arrangement by applying a force FD to the mass point corresponding to the person B in a direction from the line AB′ to the line AB. In addition, the correlation visualizing unit 103 similarly applies a force to the persons C and D to determine the arrangement of each associated person object.

As illustrated in FIGS. 3 and 4, a person who is not selected as the associated person at the time t may be selected as the associated person at the time (t+1). In this case, the correlation visualizing unit 103 can initially arrange the object 203 corresponding to the newly selected associated person in an arbitrary place. For example, the initial position may be determined by referencing any kinds of knowledge such as a social relationship or familiarity between the newly selected associated person, and the existing associated person or a probability (co-occurrence probability) that the newly selected associated person, the existing associated person, and the reference person exist in the same data.

The correlation visualizing unit 103 may create the correlation diagram illustrated in FIG. 3 by sequentially performing such a process for the focused time zone. The method for determining the arrangement of the associated person object 203 is not limited to the aforementioned example. Instead, any graph drawing technique known in the art may be used. Examples of such a graph drawing method may include various methods as disclosed in G. Di Battista, P. Eades, R. Tamassia, I. G. Tolis, “Algorithms for Drawing Graphs: an Annotated Bibliography”, Computational Geometry: Theory and Applications, 1994, 4, pp. 235-282.

In addition, the correlation visualizing unit 103 may use the relationship information and the familiarity information strictly corresponding to the time t, for example, when the correlation diagram is created at the time t. Alternatively, by giving a width to the range of the time t, the correlation diagram may be created using the relationship information and the familiarity information corresponding to the range t-Δt to t+Δt as the information at the time t.

In this manner, by giving a width to the focused time, more knowledge regarding the relationship or familiarity between persons can be used and a more accurate correlation diagram can be created.

When the correlation diagram illustrated in FIG. 3 is created, the correlation visualizing unit 103 creates a correlation map having a three-dimensional structure as illustrated in FIGS. 2A and 2B by sequentially stacking each correlation diagram such that the reference person objects 201 are positioned collinearly.

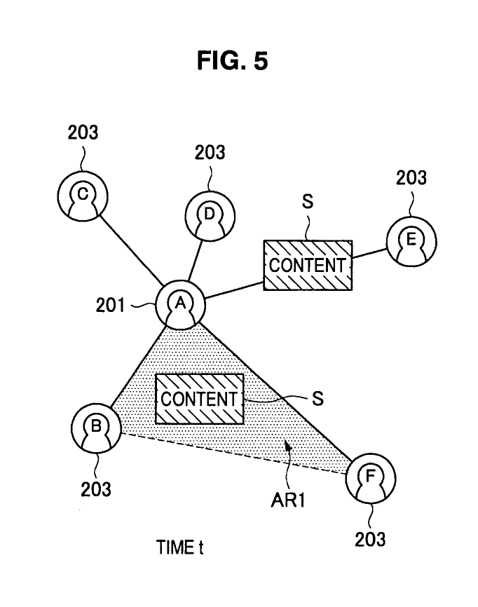

For example, as illustrated in FIG. 5, the correlation visualizing unit 103 may display and highlight such as coloring on a shape (such as the shape of the area AR1 in FIG. 5) defined by the reference person object and the associated person object considered as being included in the same group based on the relationship information.

In addition, the correlation visualizing unit 103 may arrange data (for example, a thumbnail image of the photograph data where the reference person and the associated person are photographed together) indicating a relationship between the reference person and the associated person. For example, as illustrated in FIG. 5, if the photograph data where the persons A and E are photographed together exists, the correlation visualizing unit 103 may arrange the thumbnail image S of such a photograph on the edge obtained by connecting the reference person object 201 corresponding to the person A and the associated person object 203 corresponding to the person E. In addition, if the photograph data where the persons A, B, and F are photographed together exists, the correlation visualizing unit 103 may arrange the thumbnail image S in an arbitrary position (for example, a center position of the triangle corresponding to the area AR1) within the area AR1. In this manner, by collectively displaying the data indicating a relationship between the reference person and the associated person, user's intuitive understanding regarding the social relationship can be supported. In addition, the correlation visualizing unit 103 may visualize the personal correlation by focusing on the change of the relationship between particular persons. In this case, the correlation visualizing unit 103 displays the correlation by highlighting the object corresponding to the focused person and cuts out the correlation map having a three-dimensional structure as illustrated in FIG. 2A or 2B into a plane parallel to the time axis passing through the object of the focused person. The correlation visualizing unit 103 may display a solid body defined as the obtained plane or a set of the obtained planes resulting from the cutout as the correlation map representing a relationship between particular persons.

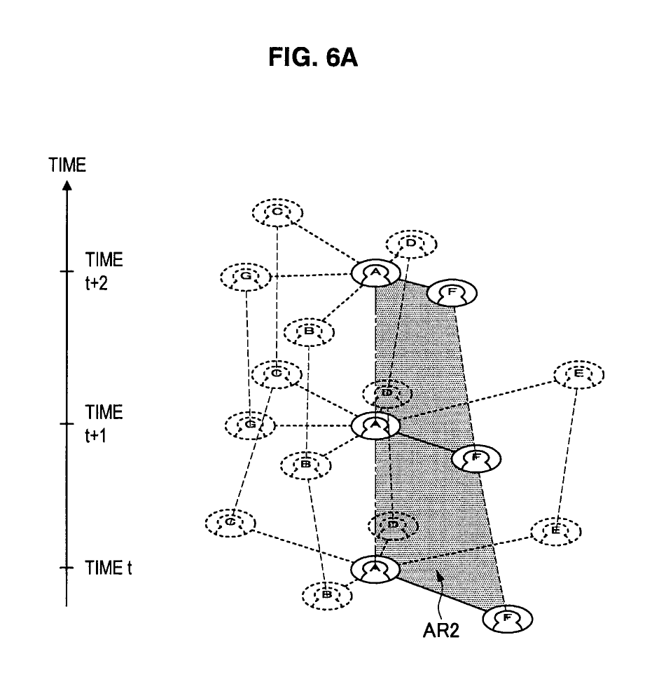

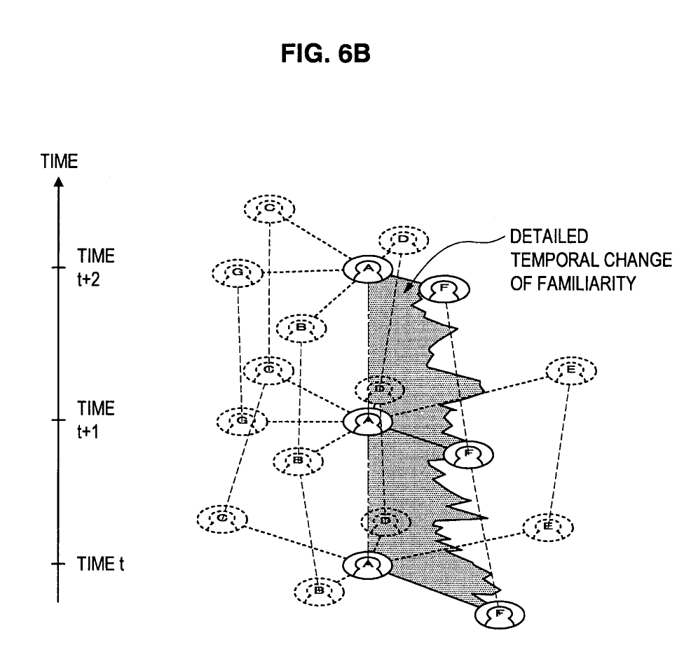

In the example of FIG. 6A, the correlation map is displayed by focusing on a combination of particular persons, that is, the persons A and F. In this case, the correlation diagram is cut out into a plane parallel to the time axis passing through both the object corresponding to the person A and the object corresponding to the person F. The plane illustrated as AR2 in FIG. 6A is displayed as the correlation map by focusing on the persons A and F. In this case, the objects other than the persons A and F may be displayed or not displayed. A user can be provided with the familiarity between persons A and F more specifically, for example, by displaying a temporal change of the familiarity between persons A and F more specifically for the plane AR2 defined in this manner as illustrated in FIG. 6B.

Hereinbefore, the correlation visualizing unit 103 according to the present embodiment has been described in detail with reference to FIGS. 2A to 6B.

Returning to FIG. 1, the relationship information creating unit 105 according to the present embodiment will be described.

The relationship information creating unit 105 is embodied, for example, as a CPU, a ROM, or a RAM. The relationship information creating unit 105 creates the relationship information representing a relationship between persons regarding a set of the aforementioned data (for example, appearing in a set of the aforementioned data) using a set of data containing time information at each point in time in the temporal sequence.

Here, the relationship information creating unit 105 may create the relationship information using a fact that the time information relating to the data group is strictly the time t when the relationship information is created at the time t, or may give a width to the range of the time t and create the relationship information using a data group corresponding to the time information having a range t-Δt to t+Δt. In this manner, if the focused time has a width, more knowledge regarding the relationship between persons can be used and more accurate relationship information can be created.

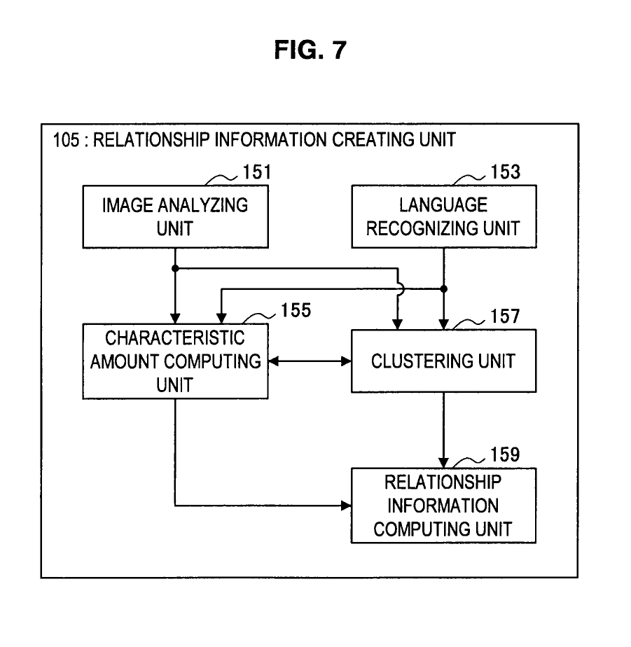

In addition, a method of creating the relationship information performed by the relationship information creating unit 105 is not particularly limited. For example, any methods known in the art such as a technique disclosed in Japanese Patent Application Laid-Open No. 2010-16796 may be used. Hereinafter, an exemplary process of creating relationship information performed by the relationship information creating unit 105 will be described in brief with reference to FIG. 7.

FIG. 7 is a block diagram illustrating an exemplary configuration of the relationship information creating unit 105 according to the present embodiment.

As illustrated in FIG. 7, the relationship information creating unit 105 according to the present embodiment further includes an image analyzing unit 151, a language recognizing unit 153, a characteristic amount computing unit 155, a clustering unit 157, and a relationship information computing unit 159.

The image analyzing unit 151 is embodied, for example, as a CPU, a ROM, or a RAM. The image analyzing unit 151 analyzes data on the image out of the data group used to create the relationship information to detect and recognize a face part included in the image. For example, the image analyzing unit 151 may output the position of the face of each subject detected from the processing target image, for example, as an XY coordinate value within the image. In addition, the image analyzing unit 151 may output the detected face size (width and height) and the detected face posture. The face area detected by the image analyzing unit 151 may be stored as a separate thumbnail image file, for example, by cutting out only a face area. When the process of analyzing the image data is finished, the image analyzing unit 151 outputs the obtained analysis result to the characteristic amount computing unit 155 and the clustering unit 157 described below.

The language recognizing unit 153 is embodied, for example, as a CPU, a ROM, or a RAM. The language recognizing unit 153 performs a language recognition process for the text data out of the data group used to create the relationship information to recognize characters described in the data or recognize the described contents. When the language recognition process for the text data is finished, the language recognizing unit 153 outputs the obtained recognition result to the characteristic amount computing unit 155 and the clustering unit 157 described below.

The characteristic amount computing unit 155 is embodied, for example, as a CPU, a ROM, or a RAM. The characteristic amount computing unit 155 is associated with the clustering unit 157 described below using the analysis result of the data group in the image analyzing unit 151, the language recognition result of the data group in the language recognizing unit 153, or the like to compute various characteristic amounts for characterizing a person relating to the focused data group. When various characteristic amounts are computed, the characteristic amount computing unit 155 outputs the obtained result to the clustering unit 157 and the relationship information computing unit 159 described below.

The clustering unit 157 is embodied, for example, as a CPU, a ROM, or a RAM. The clustering unit 157 is associated with the characteristic amount computing unit 155 to perform a clustering process for the image analysis result of the image analyzing unit 151, the language recognition result of the language recognizing unit 153, and various characteristic amounts computed by the characteristic amount computing unit 155. In addition, the clustering unit 157 may perform various pre-processings for the data for the clustering process or various post-processings for the result obtained by the clustering process. When the clustering process for various data is finished, the clustering unit 157 outputs the obtained result to the relationship information computing unit 159 described below.

The relationship information computing unit 159 is embodied, for example, as a CPU, a ROM, or a RAM. The relationship information computing unit 159 computes the relationship information indicating a social relationship of the person relating to the focused data group using various characteristic amounts computed by the characteristic amount computing unit 155, the clustering result of the clustering unit 157, and the like. The relationship information computing unit 159 computes the relationship information for the focused data group using such information and outputs the computation result to the correlation visualizing unit 103.

Then, a detailed flow of the process of creating relationship information performed by the relationship information creating unit 105 having such processing units will be exemplarily described in brief for a case where the process is performed for the image data group.

First, the image analyzing unit 151 of the relationship information creating unit 105 performs the image analysis process for the image data group to be processed, and extracts a face included in the image data group. In addition, the image analyzing unit 151 may create the thumbnail image including the extracted face part in addition to the face extraction. When the analysis of the image data group is finished, the image analyzing unit 151 outputs the obtained result to the characteristic amount computing unit 155 and the clustering unit 157.

The characteristic amount computing unit 155 computes a face characteristic amount or a similarity of the face images using the face images extracted by the image analyzing unit 151, or estimates an age or sex of the corresponding person. In addition, the clustering unit 157 performs a face clustering process for classifying the extracted face or an image time clustering process for classifying the images into time clusters based on the similarity computed by the characteristic amount computing unit 155.

Then, the clustering unit 157 performs an error removal process of the face cluster. This error removal process is performed using the face characteristic amount computed by the characteristic amount computing unit 155. It is highly likely that the face image having a significantly different face characteristic amount indicating a face attribute value is a face image of a different person. For this reason, if a different face image having a significantly different face characteristic amount is included in the face clusters classified by the face clustering, the clustering unit 157 performs an error removal process for excluding such a face image.

Then, the characteristic amount computing unit 155 computes the face characteristic amount for each face cluster using the face cluster obtained after the error removal process. It is highly likely that the face images included in the face clusters after the error removal correspond to the same person. In this regard, the characteristic amount computing unit 155 may compute the face characteristic amount for each face cluster using the face characteristic amount for each face image computed in advance. In this case, the computed face characteristic amount for each face cluster may be, for example, an average value of the face characteristic amounts of each face image included in the face clusters. Then, the clustering unit 157 performs a person computation process for each time cluster. Here, the time cluster refers to a list clustered in the unit of event based on the date/time for capturing the images. Such an event may include, for example, “sports meeting,” “journey,” and “party”. It is highly likely that the same person and the same group repeatedly appear in the images captured for such an event. In addition, since the event is a list clustered based on time, the accuracy of the person computation can be improved by performing the person computation process for designating the same person for the time cluster. Specifically, the clustering unit 157 may perform a process of integrating the face clusters using the face characteristic amount for each face cluster. The clustering unit 157 may integrate the face clusters having an approximate face characteristic amount and not appearing in the same image by considering them as a cluster of a single person.

The clustering unit 157 performs a person group computation process on a time-cluster basis. It is highly likely that the same group repeatedly appears in the image classified as the same event. For this reason, the clustering unit 157 classifies the appearing persons into groups using the information of the persons computed for each time cluster. As a result, it is highly likely that the person group computed for each time cluster has high accuracy.

Then, the clustering unit 157 performs a person/person group computation process on a time-cluster basis. The person/person group computation process on a time-cluster basis is a process of improving each of the computation accuracy by, for example, collectively using the person information and the person group information. For example, the clustering unit 157 may perform integration of the groups and re-integration of the persons according to the integration of the groups from a composition (number of persons, sexual ratio, age ratio, and the like) of the face cluster group included in the person group.

As the person information and the person group information on a time-cluster basis are created through the aforementioned process, the clustering unit 157 performs an integration process of the persons or person groups. In such a process of integrating the persons/person groups, the clustering unit 157 can designate the person and the person group on a time-cluster basis. In this case, the clustering unit 157 can further improve the designation accuracy of the person and the person group using an estimated birth year computed based on the date/time of the image capturing and the face characteristic amount for each face cluster. Through such a person/person group integration process, it is possible to obtain information regarding a transition of the group composition over time since the groups designated for each time cluster are integrated.

Then, the relationship information computing unit 159 performs a process of computing the relationship information between persons using the person information and the person group information obtained through the person/person group integration process. The relationship information computing unit 159 determines a group type, for example, from the composition of the person group and computes the social relationship based on the attribute values of each person within the group. The attribute value of the person used in this case may include, for example, a sex and an age.

Hereinbefore, an exemplary flow of the process of creating relationship information performed by the relationship information creating unit 105 according to the present embodiment has been described in brief with reference to FIG. 7.

Returning FIG. 1, description will be made for the familiarity information computing unit 107 according to the present embodiment.

The familiarity information computing unit 107 is embodied, for example, as a CPU, a ROM, or a RAM. Using a set of data containing time information, the familiarity information computing unit 107 computes the familiarity information indicating a familiarity degree between persons relating to the set of the data described above (for example, appearing in the set of the data described above) at each point in time in the temporal sequence.

Here, for example, when the familiarity information at the time t is computed, the familiarity information computing unit 107 may compute the familiarity information using a fact that the time information associated with the data group is strictly the time t or may give a width to the range of the time t so as to compute the familiarity information using the data group having time information corresponding to the range t-Δt to t+Δt. If a width is given to the focused time in this manner, it is possible to use more knowledge regarding the familiarity between persons and create more accurate familiarity information.

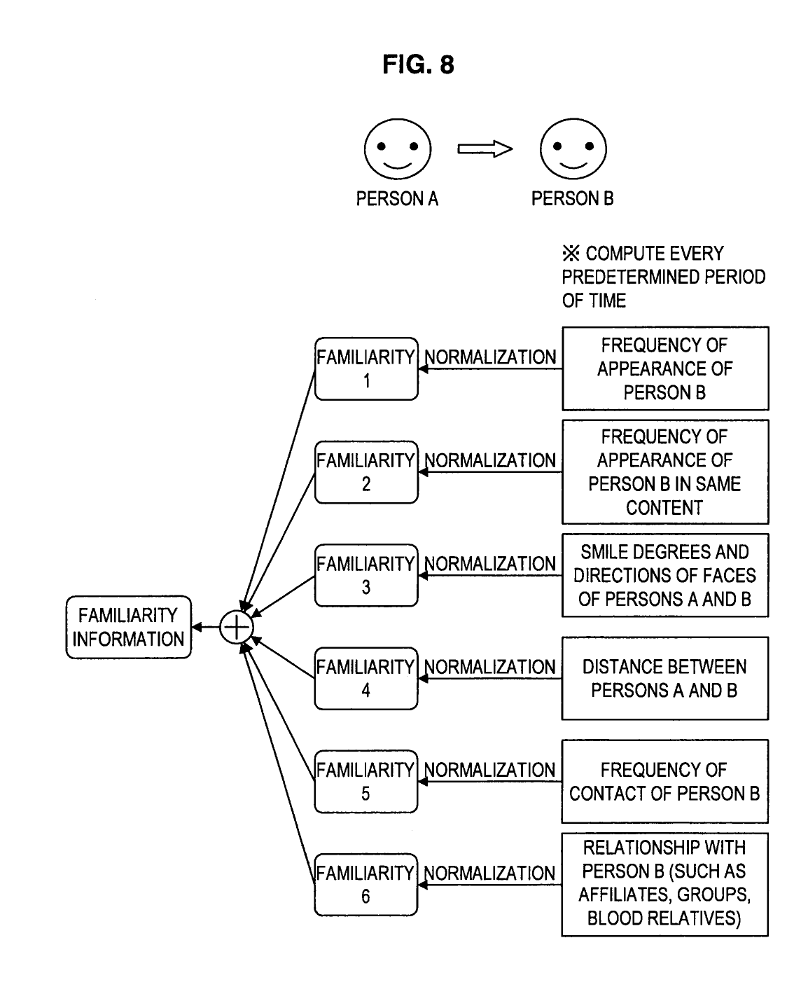

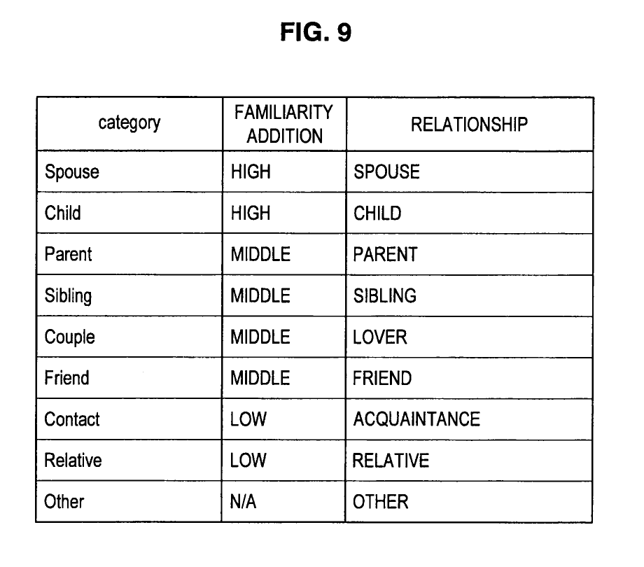

In addition, the method of creating the familiarity information in the familiarity information computing unit 107 is not limited particularly. For example, it may be possible to use any method known in the art such as a technique disclosed in Japanese Patent Application Publication Laid-Open No. 2010-16796. Hereinafter, an exemplary process of computing the familiarity information performed by the familiarity information computing unit 107 will be described in brief with reference to FIGS. 8 and 9.

FIG. 8 illustrates an example of computing the familiarity of the person B seen from the person A. In FIG. 8, for a case where the processing is performed for the image data group, the familiarity of the person B seen from the person A from six viewpoints is computed, and the familiarity information of the person B seen from the person A is obtained by summing the normalized familiarities. Such familiarity information is computed every predetermined period of time.

The familiarity information computing unit 107 treats, as a “familiarity 1,” a value obtained by normalizing the appearance frequency of the person B in the image using the data group stored in the storage unit 111 described below or person information regarding persons including the relationship information created through data analysis in the relationship information creating unit 105 and the like. When a plurality of persons exist in the same place, a possibility that the person is captured as a subject of the content such as a photograph or a moving picture increases as the familiarity between persons increases. For this reason, the familiarity 1 increases, for example, as a ratio that the person B is included as a subject out of a total number of contents created for a predetermined period of time which is the computation period increases.

The familiarity information computing unit 107 treats, as a “familiarity 2,” a value obtained by normalizing the frequency that the persons A and B appear in the same contents using the person information described above. When a plurality of persons exist in the same place, it is conceived that a possibility that the persons appear together in a photograph or a moving picture increases as the familiarity between persons increases. For this reason, the familiarity 2 increases, for example, as a ratio that the persons A and B are included in the same content as a subject out of a total number of the contents created for a predetermined period of time which is a familiarity computation period increases.

In addition, the familiarity information computing unit 107 computes the “familiarity 3” based on the smile face degree between the persons A and B and a face direction using the same person information as that described above. It is conceived that the smile face degree when gathered together increases as the familiarity of the persons A and B increases. For this reason, the “familiarity 3” increases as the smile face degree between the persons A and B increases. In addition, it is conceived that a probability that the persons A and B face each other when gathered together increases as the familiarity between persons A and B increases. For this reason, the familiarity 3 increases as the probability that the persons A and B face each other increases.

In addition, as a method of computing the smile face degree or the probability that the persons A and B face each other, any technique known in the art such as Japanese Patent Application Laid-Open No. 2010-16796 may be used.

In addition, the familiarity information computing unit 107 computes the “familiarity 4” based on a distance between the persons A and B in the image using the person information described above. Each person has a personal space. This personal space is a physical distance from the counterpart of the communication. This distance is different depending on a person and becomes closer as the relationship of the counterpart becomes more familiar, that is, as the familiarity increases. Therefore, the familiarity 4 has a higher value as the physical distance between the persons A and B in the image becomes closer.

The familiarity information computing unit 107 computes the “familiarity 5” based on the contact frequency between the persons A and B for a predetermined period of time using various data (particularly, a mail, a blog, a schedule, and history information such as a calling/called history) stored in the storage unit 111 described below. For example, this contact frequency may include a sum of the number of calls or mails transmitted/received between the persons A and B, the number of visits of the person B to the blog of the person A, and the number of appearance of the person B in the schedule of the person A.

In addition, the familiarity information computing unit 107 computes the “familiarity 5” based on a relationship between the persons A and B. This familiarity 5 may be computed, for example, using the relationship information and the like created by the relationship information creating unit 105. The familiarity information computing unit 107 may specify the relationship between the persons A and B by referencing the relationship information. For example, if information that the relationship between the persons A and B represents a marital status is obtained, the familiarity information computing unit 107 refers to the familiarity conversion table as illustrated in FIG. 9. The familiarity conversion table is information representing, for example, a matching between a relationship between persons and a familiarity sum degree. If the relationship between the persons A and B represents the marital status as described above, the familiarity sum degree in this familiarity conversion table is high. Here, although the familiarity sum is represented as high, middle, and low, a specific numerical value may be used. The familiarity information computing unit 107 sets the value of the familiarity 5 to be higher as the familiarity sum increases based on the familiarity sum degree.

In addition, the familiarity information computing unit 107 creates the familiarity information by adding the normalized familiarities 1 to 6. In addition, the familiarity information computing unit 107 may add such familiarities 1 to 6 with a weight factor. If any one of the familiarities 1 to 6 is not computed, the corresponding familiarity value may be treated as zero.

Hereinbefore, an exemplary process of computing the familiarity information which is performed by the familiarity information computing unit 107 according to the present embodiment has been described in brief with reference to FIGS. 8 and 9.

Returning to FIG. 1, the display controlling unit 109 according to the present embodiment will be described.

The display controlling unit 109 is embodied, for example, using a CPU, a ROM, a RAM, a communication device, or an output device. The display controlling unit 109 performs display control of the display screen in a display device such as a display provided in the information processing apparatus 10 or a display device such as a display provided outside the information processing apparatus 10. The display controlling unit 109 performs display control of the display screen based on user manipulation information notified from the user manipulation information creating unit 101, the information on the correlation map notified from the correlation visualizing unit 103, and the like.

The storage unit 111 is an example of a storage device provided in the information processing apparatus 10 according to the present embodiment. The storage unit 111 may store various kinds of data provided in the information processing apparatus 10, metadata corresponding to such data, and the like. In addition, the storage unit 111 may store data corresponding to various kinds of information created by the relationship information creating unit 105 and the familiarity information computing unit 107 or various kinds of data created by an external information processing apparatus. In addition, the storage unit 111 may store execution data corresponding to various applications used by the correlation visualizing unit 103 or the display controlling unit 109 to display various kinds of information on the display screen. In addition, the storage unit 111 appropriately stores various parameters, processing status, various kinds of database, and the like to be stored when the information processing apparatus 10 is in processing. The storage unit 111 can be freely used by each processing unit of the information processing apparatus 10 according to the present embodiment to read or write data.

Functions of the user manipulation information creating unit 101, the correlation visualizing unit 103, the relationship information creating unit 105, the familiarity information computing unit 107, the display controlling unit 109, and the storage unit 111 described above may be embedded in any types of hardware if the hardware can transmit/receive information to/from each other through a network. In addition, a process performed by any processing unit may be implemented in a single piece of hardware or may be distributedly implemented in a plurality of pieces of hardware.

Hereinbefore, an exemplary function of the information processing apparatus 10 according to the present embodiment has been described. Each element described above may be configured using a general-purpose member or circuit or may be configured with hardware dedicated to each function of the element. In addition, overall functions of each element may be integrated into a CPU. Therefore, the configuration may be appropriately modified depending on a technical level whenever the present embodiment is implemented.

In addition, a computer program for implementing each function of the information processing apparatus described above according to the present embodiment may be produced and embedded in a personal computer. In addition, such a computer program may be stored in a computer readable recording medium. Examples of the recording medium include a magnetic disc, an optical disc, an optical-magnetic disc, and a flash memory. In addition, the computer program described above may be delivered via a network without using a recording medium.

### <Flow of Information Processing Method>

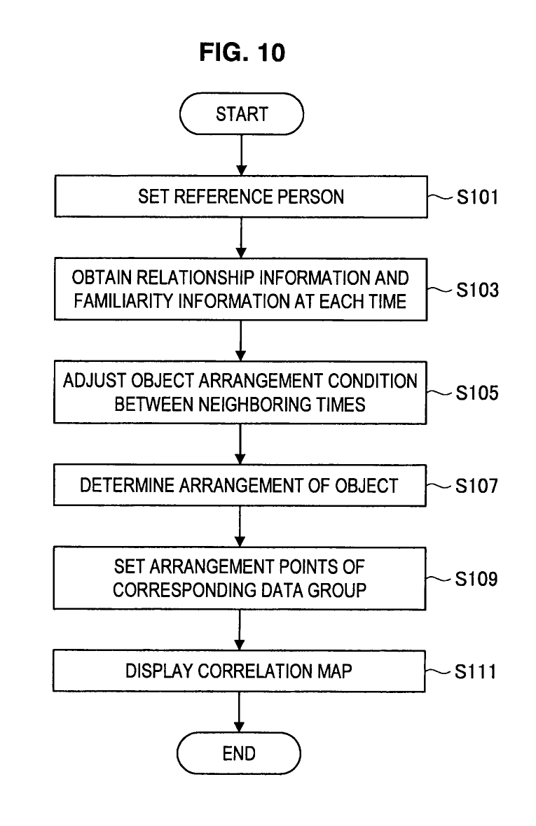

Subsequently, a flow of the information processing method performed by the information processing apparatus according to the present embodiment will be described with reference to FIG. 10. FIG. 10 is a flowchart illustrating an exemplary flow of the information processing method according to the present embodiment.

First, in step S101, the correlation visualizing unit 103 of the information processing apparatus 10 establishes a person (reference person) serving as a reference for creating a correlation map by referencing the user manipulation information and the like output from the user manipulation information creating unit 101. Then, the correlation visualizing unit 103 requests the relationship information creating unit 105 and the familiarity information computing unit 107 to create the relationship information and compute the familiarity information using information on the reference person at each time of the focused time zone.

When the relationship information created by the relationship information creating unit 105 and the familiarity information computed by the familiarity information computing unit 107 are obtained in step S103, the correlation visualizing unit 103 adjusts an arrangement condition of the objects between neighboring times using such obtained information in step S105 and determines the arrangement of the objects according to various methods in step S107.

Then, the correlation visualizing unit 103 extracts a data group to be collectively displayed on a correlation map from the data groups stored in the storage unit 111 and the like and establishes an arrangement point of the corresponding data group in the correlation map in step S109. The correlation visualizing unit 103 displays the created correlation map on a display screen through the display controlling unit 109 in step S111. As a result, the created correlation diagram is displayed on the display screen or the like of the information processing apparatus 10.

By performing processing through such a flow, a correlation diagram is displayed on a display screen of the information processing apparatus 10 or a display screen of a device capable of communicating with the information processing apparatus 10, and a user is allowed to easily recognize the social relationship of the focused person and a temporal change thereof

<First Modification>

In the first embodiment of the present disclosure described above, description has been made for a case where the reference person object as a node representing the reference person and the associated person object as a node representing the associated person are connected by a line having a length depending on the familiarity information. However, if an offset distance between the reference person object and the associated person object has a length depending on the familiarity information, they may not be connected with the line between the nodes.

In addition, the familiarity between the reference person and the associated person may not be represented as an offset distance between the corresponding objects. For example, the familiarity between both persons may be reflected using a size of the associated person object (for example, the radius of a circle corresponding to the associated person object and the like) instead of the length depending on the familiarity information.

In the information processing apparatus and the information processing method according to the present embodiment, any display method may be performed in addition to such a display method in order to reflect the familiarity between the reference person and the associated person.

(Hardware Configuration)

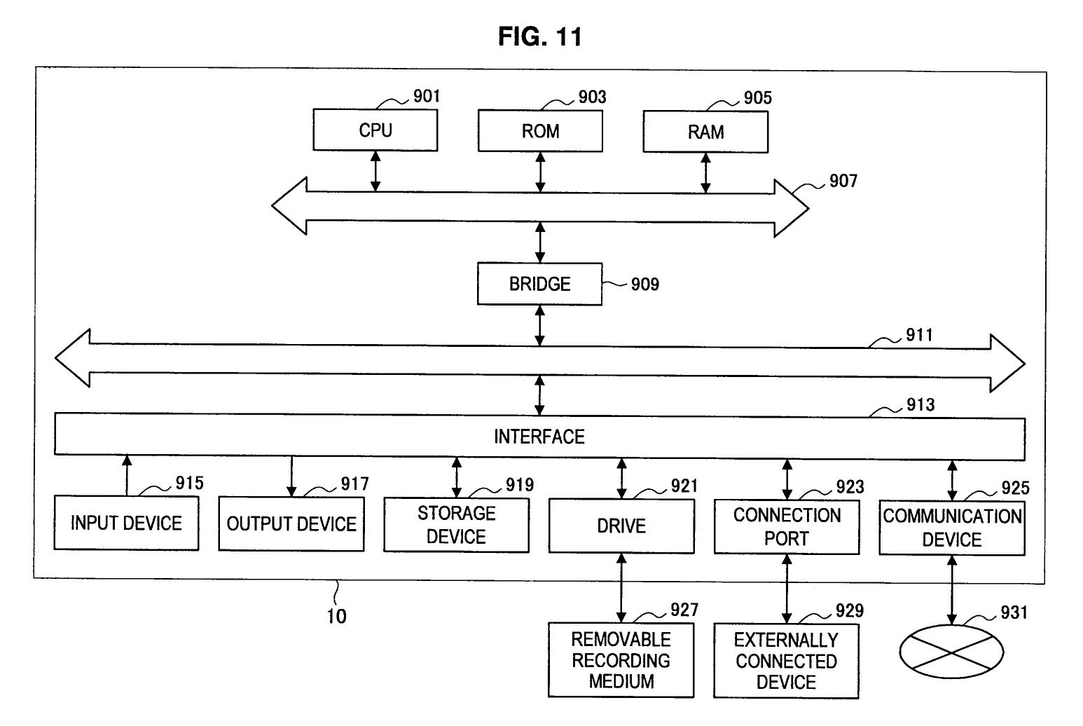

Next, the hardware configuration of the information processing apparatus 10 according to the embodiment of the present invention will be described in detail with reference to FIG. 11. FIG. 11 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs that the CPU 901 uses and parameters and the like varying as appropriate during the execution of the programs. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929. The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication, or the like.

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus comprising:

a processor that:
acquires familiarity information between a first person and a second person at each of a plurality of points in time in a temporal sequence; and
determines a distance between a first node representing the first person and a second node representing the second person at each of the plurality of points in time in a temporal sequence based on a relationship of the familiarity information between the second person and the first person at neighboring points in time in the temporal sequence.
(2) The information processing apparatus of (1), wherein the familiarity information is obtained based on content data associating the first and second person and time information corresponding to the content data.

(3) The information processing apparatus of (1), wherein the familiarity information is obtained based on image data associating the first and second person and time information corresponding to the image data.

(4) The information processing apparatus of (1), wherein the familiarity information is obtained based on text data corresponding to a communication between the first and second person and time information corresponding to the communication.

(5) The information processing apparatus of (1), wherein the familiarity information is obtained based on schedule data associating the first and second person.

(6) The information processing apparatus of (1), wherein the processor generates a map based on the determined distance between the first node and the second node at each of the plurality of points in time.

(7) The information processing apparatus of (6), wherein the processor controls a display to display the map.

(8) The information processing apparatus of (6), wherein the map has a three-dimensional structure defined by stacking a plurality of correlation diagrams that each correspond to one of the plurality of points in time in the temporal sequence.

(9) The information processing apparatus of (8), wherein each of the plurality of correlation diagrams include a first graphic corresponding to the first node and a second graphic corresponding to the second node, and a line connecting the first graphic to the second graphic.

(10) The information processing apparatus of (9), wherein the map includes a line connecting the second graphic of each of the plurality of correlation diagrams.

(11) The information processing apparatus of (9), wherein the map indicates a change in the familiarity information between the first and second person between the neighboring points in time by displaying a solid body between the first and second graphics displayed in each of the plurality of correlation diagrams.

(12) The information processing apparatus of (9), wherein the map indicates a change in the familiarity information between the first and second person between the neighboring points in time by displaying a graph indicating a detailed temporal change in familiarity between the second graphics displayed in each of the plurality of correlation diagrams.

(13) The information processing apparatus of (6), wherein the processor determines a change in position of a graphic corresponding to the second node between the neighboring points in time by applying a force to a mass point corresponding to the graphic that is generated based on a change in familiarity between the first person and the second person between the neighboring points in time.

(14) The information processing apparatus of (6), wherein the map displays data used to obtain the familiarity information between the first person and the second person.

(15) The information processing apparatus of (6), wherein the map includes a line connecting a first graphic corresponding to the first node and a second graphic corresponding to the second node, and data used to obtain the familiarity information between the first person and the second person located on the line.

(16) The information processing apparatus of (6), wherein the processor:

acquires familiarity information between a first person and a third person at each of a plurality of points in time in a temporal sequence; and

determines a distance between a first node representing the first person and a third node representing the third person at each of the plurality of points in time in a temporal sequence based on a relationship of the familiarity information between the third person and the first person at neighboring points in time in the temporal sequence.

(17) The information processing apparatus of (16), wherein the map includes data indicating an association between the first, second and third person at a position selected based on positions of graphics corresponding to the first, second and third nodes.

(18) An information processing method performed by an information processing apparatus, the method comprising:

acquiring, by a processor of the information processing apparatus, familiarity information between a first person and a second person at each of a plurality of points in time in a temporal sequence; and

determining, by the processor, a distance between a first node representing the first person and a second node representing the second person at each of the plurality of points in time in a temporal sequence based on a relationship of the familiarity information between the second person and the first person at neighboring points in time in the temporal sequence.

(19) An information processing apparatus comprising:

means for acquiring familiarity information between a first person and a second person at each of a plurality of points in time in a temporal sequence; and means for determining a distance between a first node representing the first person and a second node representing the second person at each of the plurality of points in time in a temporal sequence based on a relationship of the familiarity information between the second person and the first person at neighboring points in time in the temporal sequence.

(20) A non-transitory computer-readable medium including computer program instructions, which when executed by an information processing apparatus, cause the information processing apparatus to perform the method comprising: acquiring familiarity information between a first person and a second person at each of a plurality of points in time in a temporal sequence; and determining a distance between a first node representing the first person and a second node representing the second person at each of the plurality of points in time in a temporal sequence based on a relationship of the familiarity information between the second person and the first person at neighboring points in time in the temporal sequence.

Furthermore, the present technology may also be configured as below.
(1) An information processing apparatus including:

a correlation visualizing unit that, using relationship information representing a relationship between persons relating to a data group at each point in time in a temporal sequence of a data group and familiarity information representing a familiarity between the persons relating to the data group, computed based on a data group as a set of data containing time information, sets an arbitrary single person of the data group as a reference person, and creates a correlation map that visualizes a correlation between the reference person and an associated person, different from the reference person and associated with the reference person, and a temporal change of the correlation,

wherein the correlation visualizing unit extracts a single or a plurality of the associated persons based on the relationship information out of the data group, determines an offset distance between a node representing the reference person and a node representing the associated person at each point in time in the temporal sequence based on the familiarity information, and determines arrangement of the node representing the associated person considering a correlation of the same person between neighboring points in time in the temporal sequence.

(2) The information processing apparatus according to (1),

wherein the correlation visualizing unit arranges an object indicating presence of the data relating to both the reference person and the associated person within an area between the node representing the reference person and the node representing the associated person or within an area defined by the node representing the reference person and the nodes representing a plurality of the associated persons.

(3) The information processing apparatus according to (1) or (2), wherein the correlation visualizing unit highlights a correlation between particular persons and a temporal change of the correlation in the created correlation map.
(4) The information processing apparatus according to any one of (1) to (3), wherein, as the node representing the reference person and the node representing the associated person, the correlation visualizing unit displays an image of a corresponding person present at around the time where the nodes are positioned.
(5) The information processing apparatus according to any one of (1) to (4),

wherein the correlation visualizing unit determines arrangement of the node representing the associated person by applying a force directed to a position of the node of the same person at a previous time to a corresponding mass point based on a spring model in which the node representing the reference person and the node representing the associated person are used as mass points, and the node representing the reference person and the node representing the associated person are connected to each other with a spring having a length depending on a corresponding offset distance.

(6) The information processing apparatus according to any one of (1) to (5),

wherein the data containing time information includes image data, text data, or schedule data.

(7) An information processing method including:

by using relationship information representing a relationship between persons relating to a data group at each point in time in a temporal sequence of a data group and familiarity information representing a familiarity between the persons relating to the data group, computed based on a data group as a set of data containing time information, and by setting an arbitrary single person of the data group as a reference person, creating a correlation map for visualizing a correlation between the reference person and an associated person, different from the reference person and associated with the reference person, and a temporal change of the correlation,

wherein, in creating the correlation map, a single or a plurality of the associated persons are extracted based on the relationship information out of the data group, an offset distance between a node representing the reference person and a node representing the associated person at each point in time in the temporal sequence is determined based on the familiarity information, and arrangement of the node representing the associated person is determined taking into consideration a correlation of the same person between neighboring points in time in the temporal sequence.

(8) A program for causing a computer to implement a correlation visualizing function, the correlation visualizing function including:

by using relationship information representing a relationship between persons relating to a data group at each point in time in a temporal sequence of a data group and familiarity information representing a familiarity between the persons relating to the data group, computed based on a data group as a set of data containing time information and by setting an arbitrary single person of the data group as a reference person, creating a correlation map for visualizing a correlation between the reference person and an associated person, different from the reference person and associated with the reference person, and a temporal change of the correlation,

wherein, by the correlation visualizing function, a single or a plurality of the associated persons are extracted based on the relationship information out of the data group, an offset distance between a node representing the reference person and a node representing the associated person at each point in time in the temporal sequence is determined based on the familiarity information, and arrangement of the node representing the associated person is determined taking into consideration a correlation of the same person between neighboring points in time in the temporal sequence.

The present disclosure contains subject matter related to that disclosed in Japanese

Priority Patent Application JP 2011-131015 filed in the Japan Patent Office on Jun. 13, 2011, the entire content of which is hereby incorporated by reference.

What is claimed is:

1. An information processing apparatus comprising:
a processor that:
acquires familiarity information between a first person and a second person at each of a plurality of points in time in a temporal sequence; and
determines a distance between a first node representing the first person and a second node representing the second person at each of the plurality of points in time in a temporal sequence based on a relationship of the familiarity information between the second person and the first person at neighboring points in time in the temporal sequence.

2. The information processing apparatus of claim 1, wherein the familiarity information is obtained based on content data associating the first and second person and time information corresponding to the content data.

3. The information processing apparatus of claim 1, wherein the familiarity information is obtained based on image data associating the first and second person and time information corresponding to the image data.

4. The information processing apparatus of claim 1, wherein the familiarity information is obtained based on text data corresponding to a communication between the first and second person and time information corresponding to the communication.

5. The information processing apparatus of claim 1, wherein the familiarity information is obtained based on schedule data associating the first and second person.

6. The information processing apparatus of claim 1, wherein the processor generates a map based on the determined distance between the first node and the second node at each of the plurality of points in time.

7. The information processing apparatus of claim 6, wherein the processor controls a display to display the map.

8. The information processing apparatus of claim 6, wherein the map has a three-dimensional structure defined by stacking a plurality of correlation diagrams that each correspond to one of the plurality of points in time in the temporal sequence.

9. The information processing apparatus of claim 8, wherein each of the plurality of correlation diagrams include a first graphic corresponding to the first node and a second graphic corresponding to the second node, and a line connecting the first graphic to the second graphic.

10. The information processing apparatus of claim 9, wherein the map includes a line connecting the second graphic of each of the plurality of correlation diagrams.

11. The information processing apparatus of claim 9, wherein the map indicates a change in the familiarity information between the first and second person between the neighboring points in time by displaying a solid body between the first and second graphics displayed in each of the plurality of correlation diagrams.

12. The information processing apparatus of claim 9, wherein the map indicates a change in the familiarity information between the first and second person between the neighboring points in time by displaying a graph indicating a detailed temporal change in familiarity between the second graphics displayed in each of the plurality of correlation diagrams.

13. The information processing apparatus of claim 6, wherein the processor determines a change in position of a graphic corresponding to the second node between the neighboring points in time by applying a force to a mass point corresponding to the graphic that is generated based on a change in familiarity between the first person and the second person between the neighboring points in time.

14. The information processing apparatus of claim 6, wherein the map displays data used to obtain the familiarity information between the first person and the second person.

15. The information processing apparatus of claim 6, wherein the map includes a line connecting a first graphic corresponding to the first node and a second graphic corresponding to the second node, and data used to obtain the familiarity information between the first person and the second person located on the line.

16. The information processing apparatus of claim 6, wherein the processor:
acquires familiarity information between a first person and a third person at each of a plurality of points in time in a temporal sequence; and
determines a distance between a first node representing the first person and a third node representing the third person at each of the plurality of points in time in a temporal sequence based on a relationship of the familiarity information between the third person and the first person at neighboring points in time in the temporal sequence.

17. The information processing apparatus of claim 16, wherein the map includes data indicating an association between the first, second and third person at a position selected based on positions of graphics corresponding to the first, second and third nodes.

18. An information processing method performed by an information processing apparatus, the method comprising:
acquiring, by a processor of the information processing apparatus, familiarity information between a first person and a second person at each of a plurality of points in time in a temporal sequence; and
determining, by the processor, a distance between a first node representing the first person and a second node representing the second person at each of the plurality of points in time in a temporal sequence based on a relationship of the familiarity information between the second person and the first person at neighboring points in time in the temporal sequence.

19. An information processing apparatus comprising:
means for acquiring familiarity information between a first person and a second person at each of a plurality of points in time in a temporal sequence; and
means for determining a distance between a first node representing the first person and a second node representing the second person at each of the plurality of points in time in a temporal sequence based on a relationship of the familiarity information between the second person and the first person at neighboring points in time in the temporal sequence.

20. A non-transitory computer-readable medium including computer program instructions, which when executed by an information processing apparatus, cause the information processing apparatus to perform the method comprising:
acquiring familiarity information between a first person and a second person at each of a plurality of points in time in a temporal sequence; and
determining a distance between a first node representing the first person and a second node representing the second person at each of the plurality of points in time in a temporal sequence based on a relationship of the familiarity information between the second person and the first person at neighboring points in time in the temporal sequence.
